(19) United States
(12) Patent Application Publication
(10) Pub. No.: US 2017/0002241 A1
(43) Pub. Date: Jan. 5, 2017

(54) MOISTURE CURABLE ADHESIVE COMPOSITION BASED ON POLYLACTIDE POLYOLS

(71) Applicant: H.B. Fuller Company, St. Paul, MN (US)

(72) Inventors: Anthony J. Ostlund, Centerville, MN (US); Dorian P. Nelson, St. Paul, MN (US)

(21) Appl. No.: 15/192,398

(22) Filed: Jun. 24, 2016

Related U.S. Application Data
(60) Provisional application No. 62/187,453, filed on Jul. 1, 2015.

(51) Int. Cl. C09J 175/06; B32B 37/06; B32B 17/06; B32B 27/36; B32B 15/08; B32B 27/30; B32B 37/12; B32B 7/12

(52) U.S. Cl. CPC C09J 175/06; B32B 37/12; B32B 37/06; B32B 7/12; B32B 27/365; B32B 15/08; B32B 27/304; B32B 17/064

(57) ABSTRACT

A moisture curable adhesive composition includes an isocyanate-terminated polyurethane prepolymer that is a reaction product of a polyol component and an isocyanate component. The polyol component includes a polylactide polyol that is a reaction product of a lactide and a hydroxyl-functional initiator selected from the group consisting of glycerol, a fatty acid monoglyceride, a fatty acid diglyceride, and combinations thereof.

This application claims the benefit of U.S. Provisional Application No. 62/187,453, filed Jul. 1, 2015, which is incorporated herein.

### BACKGROUND OF THE INVENTION

The present invention is directed to a moisture curable adhesive composition, a method of making an article, and an article made thereby.

### SUMMARY OF THE INVENTION

In one aspect, the invention features a moisture curable adhesive composition that includes an isocyanate-terminated polyurethane prepolymer. The prepolymer is a reaction product of a polyol component and an isocyanate component. The isocyanate component is present relative to the polyol component at an NCO/OH ratio of from about 1:1 to about 5:1. The polyol component includes a polylactide polyol that is a reaction product of a lactide and a hydroxyl-functional initiator selected from the group consisting of glycerol, a fatty acid monoglyceride, a fatty acid diglyceride, and combinations thereof.

In one embodiment, the polyol component includes at least one additional polyol that is not a polylactide polyol.

In one embodiment, the isocyanate-terminated polyurethane prepolymer has a final percent isocyanate (% NCO) of from about 1% to about 30%, or from about 1% to about 20%, or even from about 1% to about 15%, based on the weight of the prepolymer.

In another aspect, the invention features an article including a first substrate, a second substrate, and a cured adhesive derived from any one of the aforementioned adhesive compositions sandwiched between the first and the second substrates.

In another aspect, the invention features a method of making an article. The article includes a first substrate and a second substrate. The method includes applying any one of the aforementioned adhesive compositions to a surface of the first substrate, contacting the adhesive composition with a second substrate, and curing the adhesive composition.

### DETAILED DESCRIPTION OF THE INVENTION

The present disclosure relates to a moisture curable adhesive composition, an article, and a method of making the article using the moisture curable adhesive composition.

### Moisture Curable Adhesive Composition

The moisture curable adhesive is a one component (or one-part) polyurethane composition that includes an isocyanate-terminated polyurethane prepolymer. The isocyanate-terminated polyurethane prepolymer is a reaction product of a polyol component and an isocyanate component.

The adhesive composition can be prepared by reacting the polyol component with the isocyanate component at an elevated temperature of from about 40° C. to about 200° C., or preferably between about 70° C. to about 140° C. The polyol component may first be introduced into a reaction vessel, heated to reaction temperatures and dried to remove ambient moisture absorbed by the polyols. The isocyanate component is then added to the reactor. The reaction between the polyol component and the polyisocyanate component is conducted at an NCO/OH ratio of from about 1:1 to about 5:1, preferably for hot melt moisture curable adhesives from about 1.5:1 to about 3:1, and preferably for moisture curable liquid adhesives from about 2:1 to about 5:1 to obtain an isocyanate content in the final adhesive of from about 1% to about 30%, or about 1% to about 20%, or even about 1% to about 15% by weight, based on the total weight of the adhesive composition. The resultant adhesive composition is then packaged in a suitable moisture proof container.

### Polyol Component

In one embodiment, the polyol component includes a polylactide polyol, which can be a single polylactide polyol, or a combination of different polylactide polyols.

In one embodiment, the polyol component also includes at least one additional polyol that is different from the polylactide polyol, that is, the additional polyol is not a polylactide polyol.

### Polylactide Polyol

Suitable polylactide polyols include those that have a number average molecular weight (Mₙ) of from about 500 g/mole to about 10,000 g/mole, or from about 500 g/mole to about 5,000 g/mole.

Suitable polylactide polyols also include those that have a hydroxyl (OH) functionality of no greater than 3, or from about 1.5 to about 3, or from about 1.8 to about 2.5.

In some embodiments, the polylactide polyol has a hydroxyl (OH) number of from about 8 mg KOH/g, or from about 45 mg KOH/g, or from about 110 mg KOH/g to about 350 mg KOH/g, or to about 220 mg KOH/g, or to about 170 mg KOH/g, or to about 150 mg KOH/g.

The polylactide polyol can be prepared in various known methods including ring opening addition of lactide to reactive groups of an initiator; esterification of different initiators with lactic acid; or transesterification with esters of lactic acid (e.g., ethyl lactate, butyl lactate).

In some embodiments, the polylactide polyol is a reaction product of a lactide and a hydroxyl-functional initiator.

Lactide is the cyclic di-ester of lactic acid, also known as 2-hydroxypropionic acid. Lactide has different forms such as L-lactide, D-lactide, meso-lactide, racemic lactide, or a mixture thereof, all of which can be used to produce the lactide polyol. Preferred lactide includes L-lactide, D-lactide, or meso-lactide with purities greater than 90%.

In some embodiments, the lactide is a mixture of L-lactide, D-lactide and meso-lactide in a molar ratio of meso-lactide to the combination of L-lactide and D-lactide of about 1:1 to about 4:1, preferably, from about 2:1 to about 3:1.

Examples of commercially available lactides include INGEO L100 and INGEO M300 from Natureworks, LLC (Minnetonka, Minn.).

Hydroxyl-functional initiator refers to a multifunctional alcohol that has hydroxyl functionality of from about 1.5 to about 3.5.

Examples of preferred hydroxyl-functional initiators includes glycerol, a fatty acid monoglyceride, a fatty acid diglyceride, and combinations thereof.

In some embodiments, the hydroxyl-functional initiator is a fatty acid monoglyceride.

Preferably, suitable fatty acids of the fatty acid monoglyceride and fatty acid diglyceride have a saturated or unsaturated aliphatic hydrocarbon chain including from 6 to 32 carbon atoms.

Examples of preferred fatty acids include stearic acid, oleic acid, linoleic acid, and combinations thereof. In some embodiments, glycerol monostearate (GMS) is the most preferred hydroxyl-functional initiator.

Examples of commercially available hydroxyl-functional initiators include distilled glycerol monostearate from ChemPacific (Baltimore, Md.).

The polylactide polyol is present in the composition at no less than 10% by weight, no less than 20% by weight, from about 10% to about 60% by weight, or even from about 15% to about 50% by weight.

### Additional Polyol

In some embodiments, the polyol component may include an additional polyol or mixtures of additional polyols. In some embodiments, additional polyols are liquid at ambient temperature, e.g., 25° C., and may also be referred to as an additional polyol or additional polyols herein.

Suitable additional polyols include polyether polyols, polyester polyols, polyether/polyester polyols, polycarbonate polyols, hydroxyl functional natural oil polyols, and combinations thereof. Suitable additional polyols have a hydroxyl functionality of at least about 1.5, or at least about 2, or at least about 3, and no greater than about 4, or no greater than about 3.5.

The hydroxyl number of the additional polyol may vary over a wide range, e.g., from about 8 to about 1,200, and preferably, from about 25 to about 800. The additional polyol preferably has a number average molecular weight (Mₙ) of from about 100 to about 10,000 g/mole.

Examples of suitable polyether polyols as additional polyols include those that have a number average molecular weight (Mₙ) of no less than 100 g/mole, or from about 100 g/mole to about 2500 g/mole, such as products obtained from the polymerization of a cyclic oxide, e.g., ethylene oxide, propylene oxide, butylene oxide, and tetrahydrofuran, or by the addition of one or more such oxides to polyfunctional initiators having at least two active hydrogens, e.g., water, polyhydric alcohols (e.g., ethylene glycol, propylene glycol, diethylene glycol, cyclohexane dimethanol, glycerol, trimethylol-propane, pentaerythritol and bisphenol A), ethylenediamine, propylenediamine, triethanolamine, and 1,2-propanedithiol. Particularly useful polyether polyols include, e.g., polyoxypropylene diols and triols, poly(oxyethylene-oxypropylene)diols and triols obtained by the simultaneous or sequential addition of ethylene oxide and propylene oxide to appropriate initiators and polytetramethylene ether glycols obtained by the polymerization of tetrahydrofuran.

Examples of preferred polyether polyols as additional polyols include a poly(alkylene oxide), such as poly(propylene oxide), poly(ethylene oxide) or ethylene oxide/propylene oxide copolymer with poly(propylene oxide) most preferred.

Useful polyester polyols as additional polyols are prepared from the reaction product of polycarboxylic acids, their anhydrides, their esters or their halides, and a stoichiometric excess polyhydric alcohol. Suitable polycarboxylic acids include dicarboxylic acids and tricarboxylic acids including, e.g., aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumaric acid), and alicyclic dicarboxylic acids (e.g. 1,3-cyclohexanedicarboxylic acid, and 1,4-cyclohexanedicarboxylic acid).

Examples of suitable polyols from which polyester polyols as additional polyols can be derived include aliphatic polyols, e.g., ethylene glycols, propane diols (e.g., 1,2-propanediol and 1,3-propanediol), butane diols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), neopentylglycol, 1,4-cyclohexanedimethanol, 1,4-cyclohexanediol, dimer diols, bisphenol A, bisphenol F, hydrogenated bisphenol A, hydrogenated bisphenol F, polycarprolactone polyols, tetramethylene glycol, polytetramethylene glycol, 3-methyl-1,5-pentanediol, 1,9-nonanediol, 2-methyl-1,8-octanediol, trimethylolpropane, glycerin, pentaerythritol, sorbitol, glucose, and combinations thereof.

Examples of suitable additional polyols also include natural oil polyols with hydroxyl functionality of from about 1 to about 8, and preferably from about 1.5 to about 4. Examples of suitable natural oil polyol include such as soybean oil, castor oil and rapeseed oil, as well as to those hydroxyl functional compounds that are isolated from, derived from or manufactured from natural oils including animal and vegetable oils, preferably vegetable oils. Examples of vegetable and animal oils that may be used include, but are not limited to, soybean oil, safflower oil, linseed oil, corn oil, sunflower oil, castor oil, olive oil, canola oil, sesame oil, cottonseed oil, palm oil, rapeseed oil, tung oil, fish oil, or a blend of any of these oils. Alternatively, any partially hydrogenated or epoxidized natural oil or genetically modified natural oil can be used to obtain the desired hydroxyl functionality. Examples of such oils include, but are not limited to, high oleic safflower oil, high oleic soybean oil, high oleic peanut oil, high oleic sunflower oil (such as NuSun sunflower oil), high oleic canola oil, and high erucic rapeseed oil (such as Crumbe oil).

Examples of suitable polyols from which polycarbonate polyols as additional polyols can be derived include aliphatic polyols, e.g., ethylene glycols, propane diols (e.g., 1,2-propanediol and 1,3-propanediol), butane diols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), neopentyl glycol, 1,4-cyclohexanedimethanol, 1,4-cyclohexanediol, dimer diols, bisphenol A, bisphenol F, hydrogenated bisphenol A, hydrogenated bisphenol F, tetramethylene glycol, polytetramethylene glycol, 3-methyl-1,5-pentanediol, 1,9-nonanediol, 2-methyl-1,8-octanediol, trimethylolpropane, glycerin, pentaerythritol, sorbitol, glucose, and combinations thereof, as well as polyols derived from organic oxides such as ethylene oxide and propylene oxide.

Examples of other suitable additional polyols include polyether/polyester polyols as well as mixtures of the aforementioned polyether polyols, polyester polyols, polyether/polyester polyols, and natural oil polyols.

### Catalyst

The adhesive composition may optionally include a catalyst.

Examples of suitable catalysts include tin, iron, zinc and aluminum organic salts, mineral or organic acids, and basic catalysts.

In some embodiments, the catalyst is a tin catalyst including tin (II) ethylhexanoate (SnOct₂), and dibutyl tin dilaurate.

In some embodiments, the catalyst is di(morpholine)-diethylether (DMDEE).

When present, the catalyst may be in an amount of from about 0.05% by weight to about 5% by weight, based on the weight of the adhesive composition.

### Isocyanate Component

The isocyanate component may simply be a polyisocyanate, such as 4,4′-diphenylmethane diisocyanate (MDI) and its isomers, hydrogenated MDI (H₁₂-MDI), toluene diisocyanate (TDI), xylene diisocyanate (XDI), hexamethylene diisocyanate (HDI), tris-(hexamethylene isocyanate)isocyanurate, isophorone diisocyanate, tetramethylxylene diisocyanate (TMXDI), modified diphenylmethane diisocyanate such as carbodiimide-modified diphenylmethane diisocyanate, allophanate-modified diphenylmethane diisocyanate, biuret-modified diphenylmethane diisocyanate, polymeric diphenylmethane diisocyanate, etc., and combinations thereof.

### Additives

The adhesive composition may also include other optional additives that include, e.g., antioxidants, plasticizers, adhesion promoters, catalysts, catalyst deactivators, rheology modifiers, colorants (e.g., pigments and dyes), surfactants, waxes, tackifiers, and mixtures thereof.

The adhesive may optionally include thermoplastic polymers including e.g., ethylene vinyl acetate, ethylene-acrylic acid, ethylene methacrylate and ethylene-n-butyl acrylate copolymers, polyether/polyester e.g., HYTREL material, polyvinyl alcohol, hydroxyethylcellulose, hydroxylpropylcellulose, polyvinyl methyl ether, polyethylene oxide, polyvinylpyrrolidone, polyethyloxazolines, starch, cellulose esters, and combinations thereof.

### Use

The adhesive composition is particularly useful for bonding wood, metal, and plastic substrates (e.g., PVC, ABS and polycarbonate) to various substrates including wood, metal, plastic substrates, metallic substrates, composites (e.g., polymer and wood fiber composites), glass, and combinations thereof.

In some embodiments, at least one substrate includes a material chosen from acrylonitrile-butadiene-styrene (ABS), fiber reinforced plastic (FRP), wood, wood composite panels, polyvinyl chloride (PVC), liquid crystalline polymer (LCP), paper, glass, ink-coated glass, impact modified polystyrene, polycarbonate, foamed polystyrene, metals, painted metals, or galvanized metals, or combinations thereof.

The moisture curable adhesive composition can be applied using any suitable application methods including, e.g., automatic fine line dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The moisture curable adhesive composition can be applied as a continuous or discontinuous coating, in a single or multiple layers, and combinations thereof.

The moisture curable polyurethane adhesive composition can be applied at any suitable temperature including, e.g., from about 25° C. to about 200° C., from about 60° C. to about 175° C., or even from about 90° C. to about 120° C.

Optionally, the surface of the substrate on which the moisture curable adhesive composition is applied is surface treated to enhance adhesion using any suitable method for enhancing adhesion to the substrate surface including, e.g., corona treatments, chemical treatments, flame treatments, and combinations thereof.

The moisture curable adhesive composition can be cured after application using a variety of mechanisms. The curing reaction occurs between a compound having an available active hydrogen atom and the NCO groups of the polyurethane prepolymer. A variety of reactive compounds having free active hydrogen(s) are known in the art including water, hydrogen sulfide, polyols, ammonia and other active compounds. These curing reactions may be carried out by relying on ambient moisture, or the active compounds may be added to the composition at the bond line.

The present disclosure may be better understood with reference to the following examples. These examples are intended to be representative of specific embodiments of the disclosure and are not intended to be limiting to the scope of the disclosure.

All parts, ratios, percents, and amounts stated herein and in the examples are by weight unless otherwise specified.

### EXAMPLES

Test Methods

### Viscosity

The viscosity is determined using a Brookfield Programmable Rheometer Model DV-III using Spindle #27 at 20 RPM and about 10.5 gram (g) of sample material at 75° C.±1° C. and 120° C.±1° C.

### Average Molecular Weight

Weight average molecular weight (M_{w}) and number average molecular weight (Mₙ) are determined according to ASTM D 5296-05 entitled “Standard Test Method for Molecular Weight Averages and Molecular Weight Distribution of Polystyrene by High Performance Size Exclusion Chromatography.

### Glass Transition Temperature (Tg)

Glass transition temperature (Tg) is determined by ASTM D3418-03 entitled “Standard Test Method for Transition Temperatures and Enthalpies of Fusion and Crystallization of Polymers by Differential Scanning Calorimetry”.

### Hydroxyl (OH) Number

Hydroxyl number (OH number) is determined by ASTM E 222-00 entitled “Standard Test Method for Hydroxyl Groups Using Acetic Anhydride Acetylation”.

### Percent Isocyanate (% NCO)

Percentage isocyanate (% NCO) of a prepolymer is determined by ASTM D2572-97 entitled “Standard Test Method for Isocyanate Groups in Urethane Materials or Prepolymers”.

### Open Time

Open Time is measured by drawing a 0.01 mil film at 120° C. and placing kraft paper strips on the adhesive film at 5 second intervals, using moderate application force to adhere the strips to the film. After 45-60 seconds, attempts were made to remove the strips by hand peeling them off of the adhesive film. The time interval that allows the complete strip to be removed without paper tear represents the time at which the reactive hot melt adhesive is ‘closed’ (i.e., no longer able to wet a second substrate).

### Examples

The following polylactide (PLA) polyol was used for making the adhesives to be tested in the Examples:

A PLA polyol (2000 PLA-GMS) was prepared by reacting 1035 grams of pure L-lactide (trade name INGEO® L100, Natureworks, LLC.) with 215 grams of glycerol monostearate (generic) at 120° C. for 4 hours in the presence of a catalytic amount of DABCO® T-9. After 4 hours, the catalyst was neutralized with an equal weight of H₃PO₄ (85% aq.) and the mixture was sparged with dry nitrogen gas for 1 hour at 120° C. The viscosity of the polyol was measured to be 2630 cps at 75° C. The M_{N} was found to be about 2000 g/mole.

### Examples 1-4 and Comparative Examples 1-2

Each of the adhesive compositions of examples 1-4 and comparative examples 1-2 was prepared as follows: polyether polyols and polyester polyols of the type and in the amount set forth in Table 1 and Table 2 were loaded into a glass reactor, along with listed antioxidants and additives. The mixture was dried under vacuum at 120° C. for 90 minutes. Then, diphenylmethane 4,4′-diisocyanate was slowly added to the mixture under a nitrogen blanket with vigorous stirring. After the isocyanate addition, the reaction was allowed to proceed at 120° C. under vacuum for 90 minutes or until a free isocyanate target of between 1-3% was achieved, after which time the formulation was discharged from the reactor and then stored in tin cans under nitrogen purge. The % NCO, open time, and viscosity of the resultant adhesives were tested according to the herein described test methods, and the results are also listed in Tables 1 and 2.

TABLE 1

| | Comp. | Example |
|---|---|---|
| | Exam. 1 | 1 |
| Polyester polyol - | 42 | 42 |
| HA type, 9000 | | |
| MW | | |
| Polyester polyol - | 36 | 35 |
| EAT type, 3500 | | |
| MW | | |
| Dynacoll 7130 | 10 | |
| 2000 PLA-GMS | | 10 |
| 4,4′-MDI | 10 | 11 |
| Additives | 2 | 2 |
| % NCO | 1.85 | 1.87 |
| Viscosity @ | 66800 | 33500 |
| 120° C. (cps) | | |

TABLE 2

| | Comp. | Example | Example | Example |
|---|---|---|---|---|
| | Exam. 2 | 2 | 3 | 4 |
| Dynacoll 7130 | 30.9 | | 30.4 | |
| Dynacoll 7380 | 23.5 | 23.0 | | |
| Polyester polyol - | 16.0 | 16.0 | 16.0 | 16.0 |
| HAT type, 3500 | | | | |
| MW | | | | |
| 2000 PLA-GMS | | 31.0 | 23.0 | 53.0 |
| Additives | 0.10 | 0.10 | 0.10 | 0.10 |
| CAPA 6500 | 12.5 | 11.5 | 12.0 | 10.0 |
| PDP-70L | 3.5 | 3.5 | 3.5 | 3.5 |
| MDI | 13.5 | 14.9 | 15.0 | 17.4 |
| NCO/OH | 2.32 | 2.07 | 2.16 | 2.01 |
| % NCO | 2.24 | 2.24 | 2.47 | 2.42 |
| Viscosity @ | 127,600 | 56,200 | 113,800 | 42,400 |
| 120° C. (cps) | | | | |
| Open time (sec) | 30 | 15 | 5 | 5 |

The above specification, examples and data provide a complete description of the disclosure. Since many embodiments can be made without departing from the spirit and scope of the disclosure, the invention resides in the claims hereinafter appended.

We claim:

1. A moisture curable adhesive composition comprising
an isocyanate-terminated polyurethane prepolymer that is a reaction product of a polyol component and an isocyanate component, the isocyanate component being present relative to the polyol component at an NCO/OH ratio of from about 1:1 to about 5:1, the polyol component comprising a polylactide polyol that is a reaction product of a lactide and a hydroxyl-functional initiator selected from the group consisting of glycerol, a fatty acid monoglyceride, a fatty acid diglyceride, and combinations thereof.

2. The adhesive of claim 1, wherein the polylactide polyol has a number average molecular weight of from about 500 g/mote to about 10,000 g/mole.

3. The adhesive of claim 1, wherein the polylactide polyol has a hydroxyl (OH) functionality of no greater than 3.

4. The adhesive of claim 1, wherein the fatty acid has a saturated or unsaturated aliphatic hydrocarbon chain comprising from 6 to 32 carbon atoms.

5. The adhesive of claim 1, wherein the fatty acid is selected from stearic acid, oleic acid, linoleic acid, and combinations thereof.

6. The adhesive of claim 1, wherein the polyol component further comprises an additional polyol that is different from the polylactide polyol.

7. The adhesive of claim 1, wherein the hydroxyl-functional is a fatty acid monoglyceride.

8. The adhesive of claim 1, wherein the prepolymer having a percentage isocyanate (% NCO) of from about 1% to about 30%, based on the weight of the prepolymer.

9. The adhesive of claim 1, further comprising a catalyst.

10. An article comprising a first substrate, a second substrate, and a cured adhesive derived from the adhesive composition of claim 1 sandwiched between the first and the second substrates.

11. The article of claim 10, wherein at least one of the first and the second substrates is selected from the group consisting of wood, glass, ink-coated glass, plastic substrates comprising PVC, ABS and polycarbonate, composites, metal, or galvanized metal, and combinations thereof.

12. A method of bonding a first substrate to a second substrate, the method comprising
applying the adhesive composition of claim 1 onto at least one surface of a first substrate,
contacting the adhesive composition with a second substrate, and
curing the adhesive composition.

13. The method of claim 12, wherein at least one of the first and the second substrates is selected from the group consisting of wood, glass, ink-coated glass, plastic substrates comprising PVC, ABS and polycarbonate, composites, metal, or galvanized metal, and combinations thereof.
